(19) United States
(12) Patent Application Publication
(10) Pub. No.: US 2015/0113916 A1
(43) Pub. Date: Apr. 30, 2015

(54) AUTOMATIC ROOT-CANAL TREATMENT-MATERIAL ARRANGEMENT AND SUPPLY DEVICE, AND ROOT-CANAL TREATMENT-MATERIAL PACKAGING SYSTEM COMPRISING SAME

(71) Applicant: SPIDENT CO., LTD., Incheon (KR)

(72) Inventor: Jae Hwan Kim, Seoul (KR)

(21) Appl. No.: 14/372,795

(22) PCT Filed: Apr. 26, 2013
(86) PCT No.: PCT/KR2013/003603

§ 371 Date: Jul. 17, 2014

(30) Foreign Application Priority Data
Jul. 19, 2012 (KR) 10-2012-0078648

(51) Int. Cl. B65B 35/56; A61C 19/02; B65B 35/30; A61C 5/04; B65B 3/14

(52) U.S. Cl. CPC B65B 35/56; A61C 5/04; B65B 3/14; B65B 35/30; A61C 19/02
USPC 53/148; 414/754

(57) ABSTRACT

Disclosed is a device for automatically arranging and feeding root canal treatment materials and a system for packaging the root canal treatment materials using the device, in which the device can neatly and efficiently arrange root canal treatment materials, such as root canal fillers or sorbefacients used in a root canal treatment, in such a way that the treatment materials are oriented in one direction, and can feed the arranged treatment materials; and the system can package the root canal treatment materials by automatically inserting the materials into small-sized casings. The device includes: a feeding unit feeding the root canal treatment materials in one direction; an arranging unit spaced apart from the dropping edge of the feeding unit; and a distributing unit distributing the root canal treatment materials dropping from the feeding unit.

### RELATED APPLICATION

This application is the National Stage of International Application No. PCT/KR2013/003603, filed Apr. 26, 2013, which claims benefit of foreign priority of Korean Patent Application No. 10-2011-0078648, filed Jul. 19, 2012, which is incorporated by reference in its entirety into this application.

### TECHNICAL FIELD

The present invention relates, in general, to a device for automatically arranging and feeding root canal treatment materials and a system for packaging the root canal treatment materials using the device and, more particularly, to a device for automatically arranging and feeding root canal treatment materials and a system for packaging the root canal treatment materials using the device, in which the device can neatly and efficiently arrange root canal treatment materials, such as root canal fillers or sorbefacients, used in a root canal treatment in such a way that the treatment materials are oriented in one direction, and can feed the arranged treatment materials, and the system can package the root canal treatment materials by automatically inserting the materials into a small-sized casing.

### BACKGROUND ART

A dental pulp 1 that is the inner substance inside the hard dentin of a tooth, as shown in FIG. 1, contains blood vessels, lymphatic vessels and nerves. In the dental pulp, the blood vessels, lymphatic vessels and nerves extend to a bone through a root canal 3.

In the dental pulp 1, the nerves and blood vessels may become damaged due to tooth-decay or dental trauma, thereby becoming infected or diseased, and if the infected or diseased dental pulp 1 is not removed, the infection and disease may be propagated from the dental pulp to the tooth and surrounding tissues.

Accordingly, when the dental pulp 1 is infected or diseased as described above, a root canal treatment is performed so as to prevent the tooth and surrounding tissues from being infected by the damaged or diseased dental pulp 1, in which the damaged or diseased dental pulp 1 is removed from the root canal 3 and the empty root canal 3 is filled with a specified filler.

Here, during a root canal treatment, it is required to clean the root canal 3 after removing the damaged or diseased dental pulp 1 from the root canal 3. When cleaning the root canal 3, a sorbefacient for removing debris from the root canal 3 or for drying the root canal and a root canal filler for filling the root canal 3 are used.

As shown in FIG. 2, root canal treatment materials 5 have shapes very similar to each other, and are composed of respective heads 5a and shanks 5b, and are classified into a plurality of groups according to diameter. To allow a user to easily distinguish the root canal treatment materials 5 from each other by their sizes, the heads 5a of the different groups are coated with different colors.

Silver (Ag) or a plastic material may be used as the material of the root canal fillers; particularly, Gutta-Percha Points proposed by Grossman in 1940s and made of natural latex as a chief ingredient are preferably used as the material of the root canal fillers. Paper may be used as the material of the sorbefacients; particularly, Paper Points are preferably used as the material of the sorbefacients.

The root canal treatment materials 5, such as the sorbefacients and the root canal fillers, are typically distributed to dental hospitals in a state of being packaged in a casing, as shown in FIG. 3. For example, the casing includes a casing body 11 the interior of which is partitioned by a plurality of partition walls 12, and a lid 13 mounted to the casing body 11.

Accordingly, to insert and package the root canal treatment materials 5 within the casing in such a way that treatment materials 5 are arranged with the heads 5a oriented in one direction, it is required to feed the root canal treatment materials 5 with the heads 5a oriented in one direction. Further, the arranged root canal treatment materials 5 are required to be automatically inserted and packaged within a small-sized casing.

However, in the related art, no device for automatically arranging and feeding root canal treatment materials 5 has been proposed, so, in the related art, the root canal treatment materials 5 should be manually arranged, and be manually inserted and packaged within the casing one by one. To manually arrange the small-sized root canal treatment materials 5 and to manually insert and package the materials within the casing, it increases time consumption and personnel expenses, thereby increasing the production cost. Further, the manual arrangement of the root canal treatment materials may reduce operational efficiency during insertion and packaging of the materials due to errors caused when arranging the materials.

Korean Patent No. 1083293 discloses a device for automatically arranging and feeding screws (bolts), each of Korean Patent No. 0430809 and Korean Utility Model Registration No. 0391101 discloses a device for automatically arranging and feeding nuts, and Korean Patent No. 0752271 discloses a device for automatically arranging and feeding clips.

The above-mentioned related art techniques are not proposed to be used to treat the root canal treatment materials 5, and do not propose arranging methods suitable to automatically arrange and feed the root canal treatment materials 5. Further, the related art techniques do not propose a system for automatically packaging the root canal treatment materials 5.

However, because both the root canal treatment materials 5 and the screws treated by the device disclosed in Korean Patent No. 1083293 have similar conical shapes that taper in a direction from heads to the ends of shanks, the device disclosed in Korean Patent No. 1083293 may be used to arrange the root canal treatment materials 5.

However, although the device disclosed in Korean Patent No. 1083293 can automatically arrange the screws fed by a bowl feeder 100, the device should be provided with first to fifth droppers 131 to 135 and arranges the screws in such a way that the shanks of the screws are held in a slit s, as shown in FIGS. 4 and 5, so the device has a complicated construction and may fail to realize precise arrangement of the screws, thereby yielding low productivity.

### DISCLOSURE

### Technical Problem

Accordingly, the present invention has been made keeping in mind the above problems occurring in the prior art, and an object of the present invention is to provide a device for automatically arranging and feeding root canal treatment materials and a system for packaging the root canal treatment material using the device, in which the device can neatly and efficiently arrange the root canal treatment materials used in a root canal treatment in such a way that the treatment materials are oriented in one direction, and can feed the arranged treatment materials, and the system can package the root canal treatment materials by automatically inserting the materials into a small-sized casing.

### Technical Solution

In order to accomplish the above objects, the present invention provides a device for automatically arranging and feeding root canal treatment materials, the device including: a feeding unit feeding the root canal treatment materials in one direction, with a dropping edge formed on an end of the feeding unit so as to drop the root canal treatment materials; and an arranging unit spaced apart from the dropping edge of the feeding unit by a distance for arrangement and arranging the root canal treatment materials such that the materials are oriented in the same direction; and a distributing unit distributing the root canal treatment materials dropping from the feeding unit, wherein the distance for arrangement is adjusted in such a way that, when a root canal treatment material is being fed with the head oriented in a feeding direction, the root canal treatment material directly drops just after passing the dropping edge; and when a root canal treatment material is being fed with the shank oriented in the feeding direction, the root canal treatment material comes into contact with the arranging unit after passing the dropping edge, and drops while being rotated by an angle of 180°.

Here, the arranging unit may include: a horizontal contact plate arranged in parallel to the feeding direction, in which an end of the horizontal contact plate facing the dropping edge is spaced apart from the dropping edge by the distance for arrangement, wherein the root canal treatment material being fed with the shank oriented in the feeding direction drops with the end of the shank placed on the horizontal contact plate, so the root canal treatment material is rotated by an angle of 180°.

Further, an end of the horizontal contact plate may be provided with a downward bent portion, and the root canal treatment material being fed with the shank oriented in the feeding direction drops with the end of the shank moving upward over the downward bent portion, so the root canal treatment material is rotated by an angle of 180°.

The device may further include: a counter installed on the distributing unit so as to count the number of the root canal treatment materials discharged by the distributing unit; and a returning unit installed on an upper stream of the distributing unit so as to blow air onto root canal treatment materials being fed toward the distributing unit, thereby returning the materials to the feeding unit, wherein, when the number of the discharged root canal treatment materials counted by the counter becomes equal to a preset number, the returning unit returns excessive root canal treatment materials to the feeding unit.

In another aspect, the present invention provides a system for packaging root canal treatment materials, comprising: a plurality of devices for automatically arranging and feeding root canal treatment materials; and an automatic casing supplying unit including: a plurality of casing grip units holding respective casings; and a grip moving unit moving the casing grip units simultaneously, wherein a plurality of devices for automatically arranging and feeding root canal treatment materials are sequentially arranged in a linear arrangement, and the grip moving unit sequentially moves the casing grip units to the distributing units of the devices such that the root canal treatment materials discharged from the distributing units are inserted into the casings.

The system may further include: a casing feeder feeding the respective casings to the casing grip units.

### Advantageous Effects

According to the present invention, when a root canal treatment material is being fed with the heavy head of the material oriented in a feeding direction, the root canal treatment material directly drops, and when a root canal treatment material is being fed with the light shank of the material oriented in the feeding direction, the root canal treatment material comes into contact with an arranging unit and drops while being rotated by an angle of 180°.

Accordingly, in the present invention, the device can automatically arrange the root canal treatment materials, such as root canal fillers or sorbefacients, used in a root canal treatment in such a way that the treatment materials are oriented in one direction, and can feed the arranged treatment materials, and the system can package the root canal treatment materials by automatically inserting the materials into a small-sized casing. Thus, the present invention can reduce the time required to package the root canal treatment materials and can realize precise arrangement of the treatment materials, thereby reducing personnel expenses and yielding high productivity.

### BRIEF DESCRIPTION OF DRAWINGS

FIG. 1 is a cross-sectional view of a molar tooth;

FIG. 2 is a perspective view of a conventional root canal treatment material;

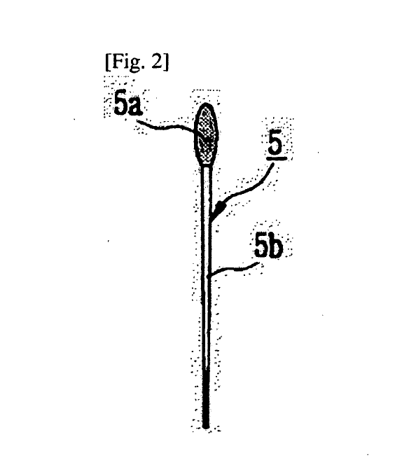

FIG. 3 is a perspective view of a casing and root canal treatment materials packaged in the casing;

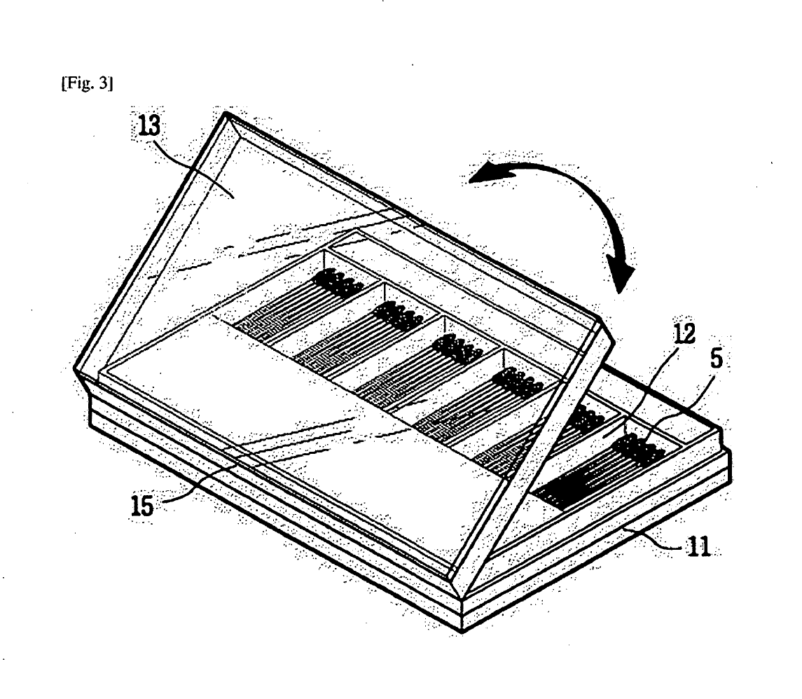

FIG. 4 is a perspective view of a conventional automatic arranging device;

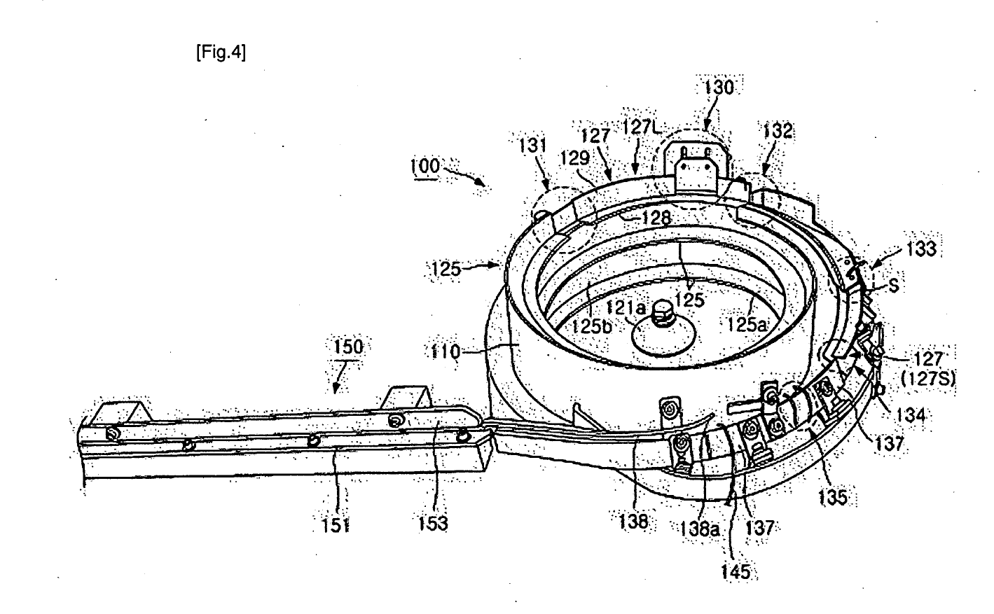

FIG. 5 is an enlarged view of a part of the automatic arranging device shown in FIG. 4;

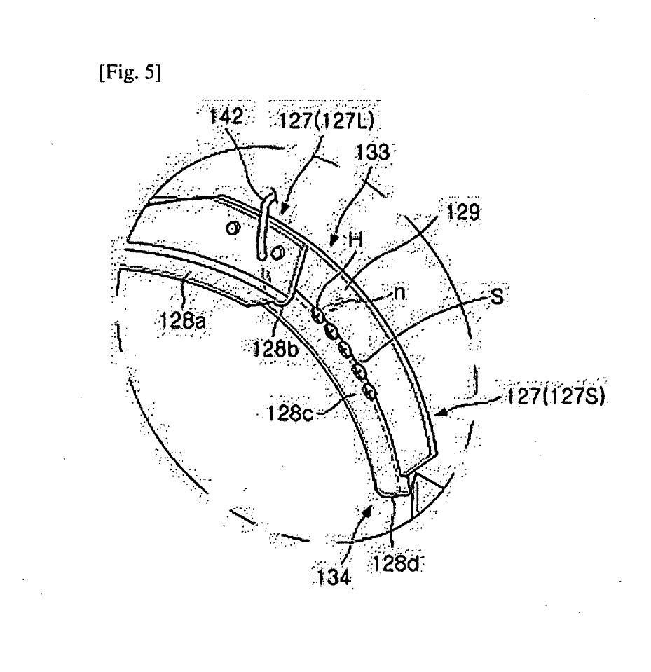

FIG. 6 is a perspective view illustrating a device for automatically arranging and feeding root canal treatment materials according to a first embodiment of the present invention, and a root canal treatment material packaging system incorporating the device;

FIG. 7 is a partially enlarged view of an arranging unit of the device for automatically arranging and feeding the root canal treatment materials according to the first embodiment of the present invention;

FIG. 8 is a view illustrating an arranging method performed by the device for automatically arranging and feeding the root canal treatment materials according to the first embodiment of the present invention;

FIG. 9 is a view of a modification of the arranging unit of the device for automatically arranging and feeding the root canal treatment materials according to the first embodiment of the present invention;

FIG. 10 is a perspective view illustrating a device for automatically arranging and feeding root canal treatment materials according to a second embodiment of the present invention, and a root canal treatment material packaging system incorporating the device;

FIG. 11 is a perspective view of a feeding unit of the device for automatically arranging and feeding the root canal treatment materials according to the second embodiment of the present invention;

FIG. 12 is a partially enlarged view of an arranging unit of the device for automatically arranging and feeding the root canal treatment materials according to the second embodiment of the present invention;

FIG. 13 is a partially enlarged view illustrating a counter and a returning unit of the root canal treatment material packaging system according to the second embodiment of the present invention; and

FIG. 14 is a view illustrating an automatic casing supplying unit and a casing feeder of the root canal treatment material packaging system according to the second embodiment of the present invention.

### DESCRIPTION OF THE REFERENCE NUMERALS IN THE DRAWINGS

210, 410: feeding unit (bowl feeder)
220, 420: arranging unit
221, 221a, 221b, 421: horizontal contact plate
222, 422: base frame
223, 423: adjusting hole
224, 424: adjusting bolt
230, 430: distributing unit (line feeder)
240, 440: returning unit
250, 450: counter
310: casing grip unit
320: grip moving unit
330: casing feeder
B1, B2: casing
5: root canal treatment materials (root canal fillers or sorbefacients)

### DETAILED DESCRIPTION

Hereinbelow, a device for automatically arranging and feeding root canal treatment materials and a system for packaging the root canal treatment materials using the device according to a preferred embodiment of the present invention will be described in detail with reference to the accompanying drawings.

In the following description of the present invention, it is noted that “root canal treatment materials” may be a variety of materials including sorbefacients (for example, Paper Point™) used to remove debris from a root canal or to dry the root canal when cleaning the root canal during a root canal treatment and root canal fillers (for example, Gutta-Percha Point™) used to fill the root canal during the root canal treatment.

Further, although the root canal fillers and the sorbefacients are made of different materials, the fillers and the sorbefacients have the same or similar conical shapes, and theories thereof adapted to the present invention are the same practically, so the root canal fillers will be described hereinbelow as an example of the root canal treatment materials.

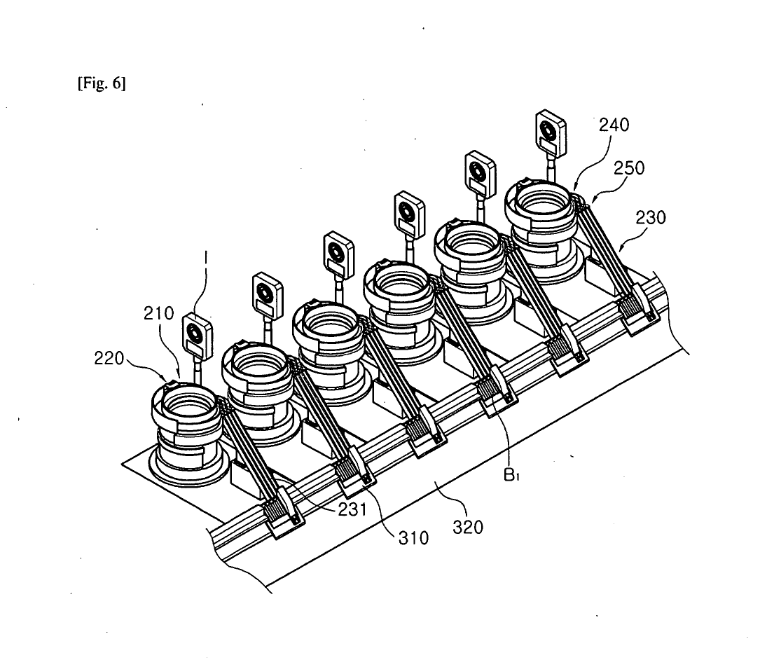

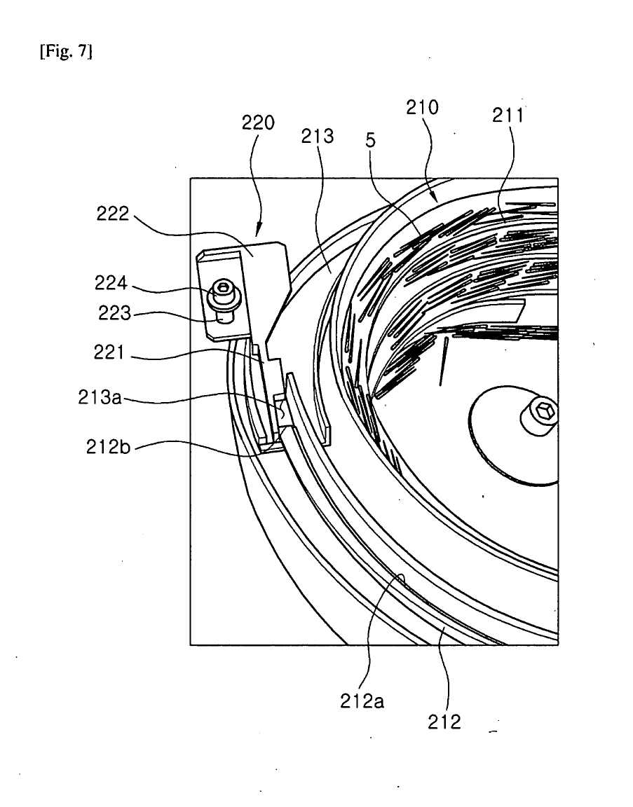

As shown in FIGS. 6 and 7, a device for automatically arranging and feeding root canal treatment materials according to a first embodiment of the present invention includes: a feeding unit 210 that feeds root canal fillers 5 in one direction, with a dropping edge 212b provided at an end of the feeding unit 210 so as to drop the root canal fillers 5 from a dropping edge; an arranging unit 220 that is spaced apart from the dropping edge 212b of the feeding unit 210 by a distance for arrangement and arranges the root canal fillers 5 such that all the fillers 5 are oriented in one direction; and a distributing unit 230 that distributes the root canal fillers 5 dropping from the feeding unit 210.

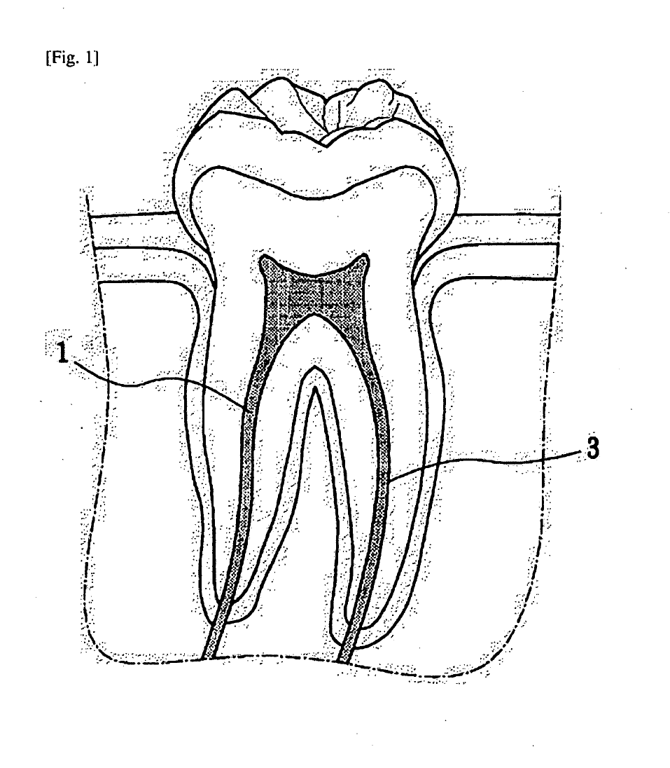

Here, in the same manner as that described with reference to FIG. 1, each of the root canal fillers 5 used to fill a root canal 3 after removing diseased dental pulp 1 from the root canal 3 and cleaning the root canal 3 during a root canal treatment has a conical shape that tapers from a head 5a to the end of a shank 5b. Due to the tapering shape, the center of gravity of each root canal filler 5 having about a length of approximately 28 mm is not located at the axial center of the filler.

Accordingly, when the distance for arrangement has been appropriately adjusted and a root canal filler 5 is being fed with the head 5a oriented in a feeding direction, the root canal filler 5 will directly drop just after passing the dropping edge 212b. However, when a root canal filler 5 is being fed with the shank 5b oriented in the feeding direction, the root canal filler 5 will come into contact with the arranging unit 220 after passing the dropping edge 212b and will drop while being rotated by an angle of 180°.

In other words, when a root canal filler 5 is being fed with the head 5a oriented in the feeding direction, the root canal filler 5 will directly drop without changing the direction thereof. However, when a root canal filler 5 is being fed with the shank 5b oriented in the feeding direction, the root canal filler 5 will drop while being rotated by an angle of 180°. Thus, even when the root canal fillers 5 are being fed with the heads 5a or the shanks 5b randomly oriented in the feeding direction, the device of the present invention automatically arrange the fillers 5 in such a way that the heads 5a are oriented in the feeding direction when the fillers 5 pass the arranging unit 220.

The device of the present invention further includes a counter 250 that is installed on the distributing unit 230 and counts the number of the root canal fillers 5 discharged by the distributing unit 230, and a returning unit 240 that is installed on the upper stream of the distributing unit 230 and blows pressurized air to excessive root canal fillers 5 placed on the upper stream of the distributing unit 230 so as to return the excessive fillers 5 to the feeding unit 210. Accordingly, when the number of the discharged root canal fillers 5 counted by the counter 250 becomes equal to a preset number, the returning unit 240 returns excessive root canal fillers 5 to the feeding unit 210, so the device can insert the preset number of fillers 5 into a casing B1.

Described in more detail, the feeding unit 210 is a unit that feeds root canal fillers 5 in one direction. In the present invention, a bowl feeder may be used as an example of the feeding unit 210, as shown in FIG. 7. Hereinbelow, the feeding unit 210 of the present invention will be referred to the “bowl feeder 210”.

The bowl feeder 210 is provided with a spiral track 211 on the inner circumferential surface thereof, with a vibrator (not shown) connected to the bowl feeder 210. When vibrations are applied from the vibrator to the bowl feeder 210, the root canal fillers 5 are fed while being raised upward by the spiral track 211.

Further, the bowl feeder 210 is provided with a line feeding track 212 on the upper part thereof, with an arranging groove 212a formed along the line feeding track 212 so as to feed the root canal fillers 5 one by one even when the fillers 5 are fed chaotically.

In other words, the fillers 5 set in the arranging groove 212a will be fed to the arranging unit 220, while the fillers placed outside the groove 212a will drop onto the bottom of the bowl feeder 210. Here, the root canal fillers 5 dropping onto the bottom of the bowl feeder 210 are raised upward so as to be fed again.

Further, the dropping edge 212b that is formed on the end of the line feeding track 212 as described above is connected to a connection track 213, so the root canal fillers 5 that have dropped through a dropping hole 213a after passing passed the dropping edge 212b is guided to the connection track 213.

The connection track 213 is configured to connect the feeding unit 210 and the distributing unit 230 to each other, so the root canal fillers 5 that have been fed and dropped one by one are sequentially guided to the distributing unit 230 via the connection track 213. Thus, the root canal fillers 5 from the distributing unit 230 are automatically inserted into the casing B1.

Here, a tiltable ionizer I is installed at a side of the bowl feeder 210 so as to remove static electricity that may be charged on the surfaces of the root canal fillers 5.

The arranging unit 220 is configured to arrange the root canal fillers 5 such that the fillers are oriented in one direction. In the present invention, the arranging unit 220 is placed on a side of the bowl feeder 210, that is, on a path extending from the line feeding track 212 to the connection track 213.

As shown in FIG. 7, the arranging unit 220 includes: a horizontal contact plate 221 that arranges the root canal fillers 5, a base frame 222 that supports the horizontal contact plate 221, an adjusting hole 223 that is formed through the base frame 222, and an adjusting bolt 224 fastened to the adjusting hole 223.

The horizontal contact plate 221 is placed in parallel to a direction in which the root canal fillers 5 are fed. Here, the end of the horizontal contact plate 221 which faces the dropping edge 212b is spaced apart from the dropping edge 212b by the distance for arrangement, so root canal fillers 5 that are being fed with the shanks 5b oriented to the feeding direction will drop while being rotated by an angle of 180° with the ends of the shanks 5b placed on the horizontal contact plate 221.

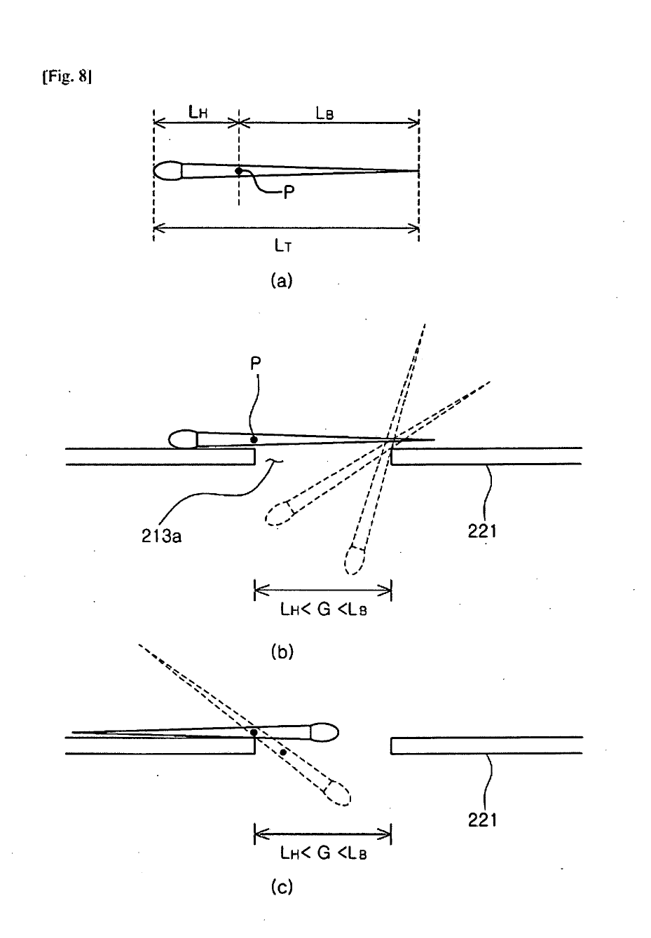

As shown in FIG. 8a, the center of gravity P of each root canal filler 5 is not located at the axial center thereof, but is biased toward the head 5a, so the length LB from the center of gravity P to the end of the shank 5b is greater than the length LH from the center of gravity P to the head 5a.

Further, as shown in FIGS. 8b and 8c, the gap G (that is, the distance for arrangement) between the dropping edge 212b and the horizontal contact plate 221 is greater than the length LH from the center of gravity P to the head 5a, and is shorter than the length LB from the center of gravity P to the end of the shank 5b.

Accordingly, as shown in FIG. 8b, when a root canal filler 5 is being fed with the shank 5b oriented in the feeding direction, the filler 5 will be placed such that a part of the end of the shank 5b is positioned on the horizontal contact plate 221, and when a next root canal filler 5 reaches the position in the above state, the first root canal filler 5 is rotated by an angle of 180° while dropping.

When the root canal filler 5 is rotated by an angle of 180° while dropping as described above, the filler 5 is arranged such that the direction of the filler 5 is changed by the rotation from the previous direction in that the shank 5b is oriented in the feeding direction to a new direction in that the head 5a is oriented in the feeding direction. Thus, the device of the present invention can feed all the root canal fillers 5 to the distributing unit 230 in an arranged state with the heads 5a of the fillers 5 oriented in the feeding direction.

On the contrary, when a root canal filler 5 is being fed with the head 5a oriented in the feeding direction as shown in FIG. 8c, the root canal filler 5 will directly drop just after passing the dropping edge 212b. Here, the terms “directly dropping” mean that the root canal filler 5 directly drops without being rotated by an angle of 180° or without changing the direction of the filler although the filler comes into contact with the horizontal contact plate 221 or the filler is placed on the horizontal contact plate 221.

When a root canal filler 5 is being fed with the head 5a oriented in the feeding direction, the root canal filler 5 will directly drop just after passing the dropping edge 212b and will be fed to the distributing unit 230 in the dropping state without changing the direction thereof because the length LH from the center of gravity P to the head 5a is shorter than the gap G between the dropping edge 212b and the horizontal contact plate 221.

In other words, although the root canal fillers 5 are being fed chaotically in states shown in FIGS. 8b and 8c, the present invention can arrange all the fillers 5 such that the heads 5a of the fillers are oriented in the feeding direction.

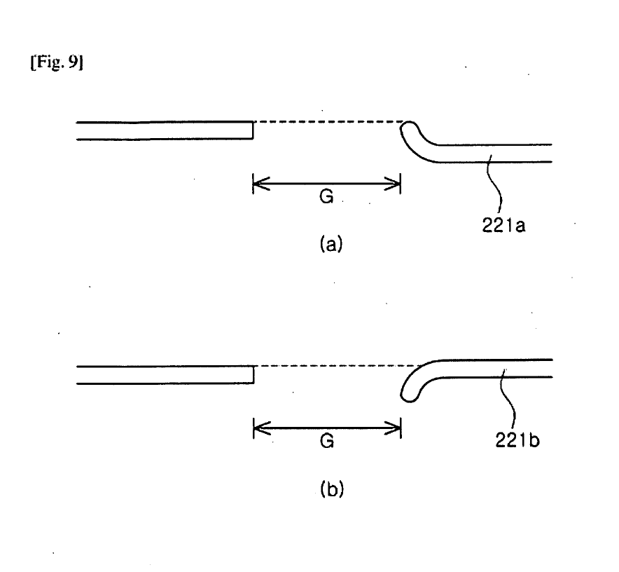

Here, the horizontal contact plate 221 may be configured as a flat plate as shown in FIG. 8. However, the horizontal contact plate 221 may be configured as an upward bent contact plate 221a having an upward bent portion as shown in FIG. 9a, or as a downward bent contact plate 221b having a downward bent portion as shown in FIG. 9b.

When using the upward bent contact plate 221a of FIG. 9a, the plate 221a is installed such that the height of the uppermost end of the upward bent portion becomes equal to the height of the root canal filler 5 that is being fed, so the upward bent contact plate 221a can perform the same function as that of the horizontal contact plate 221. The upward bent contact plate 221a of FIG. 9a may be used more efficiently when it is required to form a bent portion in the feeding path.

When using the downward bent contact plate 221b of FIG. 9b, the plate 221b is installed such that the height of the initial bent portion of the plate 221b becomes equal to the height of the root canal filler 5 that is being fed, so the filler 5 will come into contact with the initial bent portion of the plate 221b. Accordingly, when a root canal filler 5 that is being fed with the shank 5b oriented in the feeding direction reaches the downward bent contact plate 221b, the end of the shank 5b moves upward over the initial bent portion of the plate 221b and the filler 5 drops, so that filler 5 is rotated by an angle of 180°. Thus, due to the bent portion of the bent contact plate, the device of this invention can more efficiently rotate the root canal fillers 5 when the root canal fillers 5 are being fed with the shanks 5b oriented in the feeding direction.

Turning to FIG. 7, the horizontal contact plate 221 of the arranging unit 220 is supported by the base frame 222, and the adjusting hole 223 that is formed through the base frame 222 has a longitudinal hole shape. Accordingly, when fastening the horizontal contact plate 221 to the base frame 222 using the adjusting bolt 224 after adjusting the position of the horizontal contact plate 221, the adjusted position of the horizontal contact plate 221 is fixed.

The gap G (the distance for arrangement) between the dropping edge 212b of the bowl feeder 210 and the horizontal contact plate 221 can be adjusted by the above-mentioned method. Here, the distance for arrangement G may be preset in such a way that the distance for arrangement G is greater than the length LH from the center of gravity P to the head 5a of the filler 5 and is shorter than the length LB from the center of gravity P to the shank 5b.

However, the above-mentioned definition for the dimensions is created for clear description of the present invention using both the total length of the root canal filler 5 and the information about the center of gravity P of the filler 5, so it is obvious to those skilled in the art that it is required to set the precise distance for arrangement in practical use with the consideration of: an inertia force generated by the feeding speed for the root canal fillers 5, the total weight of the root canal fillers 5, etc.

The distributing unit 230 functions to receive the root canal fillers 5 dropping from the feeding unit 210 and to distribute the fillers 5. As an example of the distributing unit 230, a line feeder may be used. Hereinbelow, the distributing unit 230 of the present invention will be referred to the ‘line feeder 230’.

The upper end of the line feeder 230 is connected to the connection track 213 of the bowl feeder 210, so the root canal filler 5 that drops while being arranged by the arranging unit 220 is put on the line feeder 230 via the connection track 213. After being put on the line feeder 230, the root canal filler 5 slides down along a distributing track 231 of the line feeder 230.

To this end, the line feeder 230 is inclinedly installed to form a slant path. A casing B1 for receiving the root canal fillers 5 is placed near the lower end of the line feeder 230. Accordingly, the root canal fillers 5 that slide down along the line feeder 230 are naturally inserted into the casing B1, thereby being automatically packaged in the casing B1.

Here, as described above, the counter 250 functioning to count the number of the root canal fillers 5 distributed by the line feeder 230 is installed on the line feeder 230, and the returning unit 240 functioning to blow pressurized air to excessive root canal fillers 5 so as to return the excessive fillers 5 to the feeding unit 210 is installed on an upper stream of the line feeder 230.

Here, the counter 250 may be provided with a sensor for sensing and counting the root canal fillers 5 when the fillers sequentially pass the sensor on the line feeder 230, and the returning unit 240 may be provided with an air supplying pipe and an air ejection nozzle, so the returning unit 240 can return excessive root canal fillers 5 to the bowl feeder 210 by blowing highly pressurized air to the excessive fillers from the air ejection nozzle.

Accordingly, when the number of the discharged root canal fillers 5 counted by the counter 250 becomes equal to a preset number, the returning unit 240 returns excessive root canal fillers 5 to the feeding unit 210, so the device can insert only the preset number of fillers 5 into the casing B1.

Further, the system for packaging root canal fillers according to the present invention includes: a plurality of arranging and feeding devices 210 to 250 each having the above-mentioned construction and functioning to automatically arrange and feed root canal treatment materials, and an automatic casing supplying unit 310 and 320, wherein the automatic casing supplying unit 310 and 320 comprises a plurality of casing grip units 310 that grip respective casings B1, and a grip moving unit 320 that moves the casing grip units 310 simultaneously.

Here, if the casing grip unit 310 can efficiently grip the casing B1, the casing grip unit 310 may be freely designed without limiting the shape of the casing grip unit 310. As an example, a feeding fork may be used as the casing grip unit 310, as shown in the drawings. In the present invention, the number of the casing grip units 310 is equal to or greater than the number of the feeding units 210, so the casing grip units 310 may be placed at locations near the outlets of the plurality of line feeders 230, respectively.

Further, the grip moving unit 320 may comprise a ball screw (LM guide), a motor for driving the ball screw, etc. The grip moving unit 320 may be operated in such a way that it can move the plurality of casing grip units 310 simultaneously under the control of a controller, thereby allowing the root canal fillers 5 distributed from the feeding units to be supplied to the plurality of casings B1.

In the embodiment of FIG. 6, six devices for automatically arranging and feeding root canal treatment materials are sequentially installed in a linear arrangement, and a plurality of casing grip units 310 that grip respective casings B1 are placed at locations near the outlets of the line feeders 230 of the six devices, wherein the casing grip units 310 are sequentially moved to next arranging and feeding devices by the grip moving unit 320.

In the embodiment, the present invention is configured such that it can feed and package six kinds of root canal fillers 5 in each casing B1, wherein the kinds of the root canal fillers 5 may be classified by the diameters of the heads of the fillers. To this end, the packaging system of this invention may be configured such that the six kinds of root canal fillers 5 are distributed from the six devices, respectively, and a plurality of casings B1 held by the respective casing grip units 310 and each having six chambers partitioned by the plurality of partition walls 12 are sequentially moved so as to receive the different kinds of root canal fillers 5 distributed from the respective devices every when the casings are sequentially moved to the devices. Thus, the present invention can package the six kinds of root canal fillers 5 in each casing B1.

Hereinbelow, a device for automatically arranging and feeding root canal treatment materials according to the second embodiment of the present invention, and a root canal treatment material packaging system incorporating the device will be described with reference to the accompanying drawings.

As described above, the first embodiment of the present invention is configured such that the root canal fillers 5 of the same kind are sequentially fed one by one by one arranging and feeding device, and different kinds of root canal fillers 5 are fed by respective devices.

In the second embodiment of the present invention, the general shapes of the arranging and feeding device and the packaging system remain the same as in or are similar to the first embodiment, but the alteration is that a plurality of root canal fillers 5 of the same kind, for example, three root canal fillers 5 of the same kind are fed at the same time from one arranging and feeding device, and further explanation for the same or similar elements may be thus omitted.

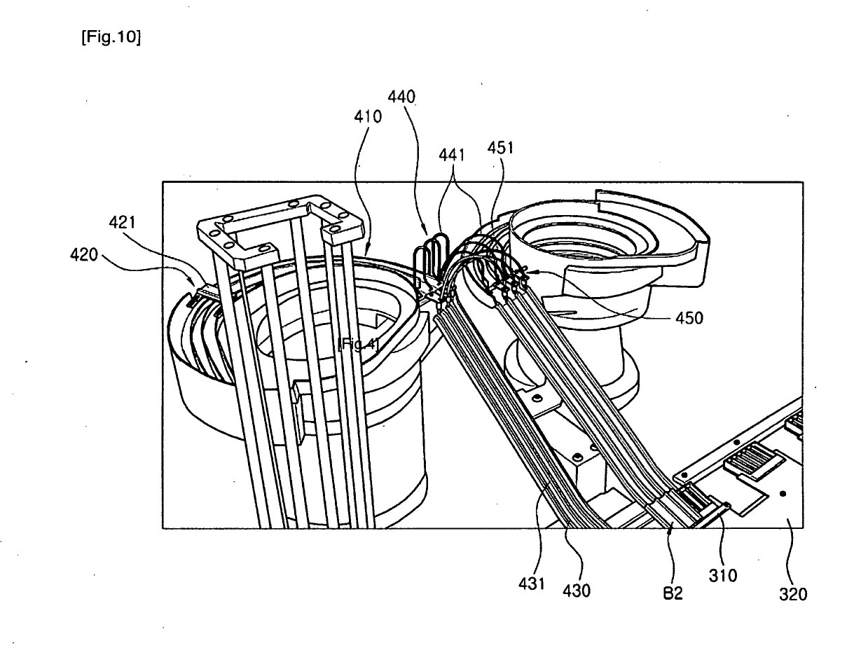

As shown in FIG. 10, the device for automatically arranging and feeding root canal fillers 5 according to the second embodiment of the present invention includes: a feeding unit 410 that feeds the root canal fillers 5 in one direction; an arranging unit 420 that is spaced apart from a dropping edge 412b of the feeding unit 410 by the distance for arrangement G and arranges the root canal fillers 5 such that all the fillers 5 are oriented in one direction; and a distributing unit 430 that distributes the root canal fillers 5 dropping from the feeding unit 410.

Further, the device according to the second embodiment of the present invention further includes a counter 450 that is installed on the distributing unit 430 and counts the number of the root canal fillers 5 discharged by the distributing unit 430, and a returning unit 440 that is installed on the upper stream of the distributing unit 430 and ejects pressurized air to excessive root canal fillers 5 so as to return the excessive fillers 5 to the feeding unit 410. Here, signal cables 451 are connected to the counter 450, and air supplying pipes 441 are connected to the returning unit 440.

Further, the second embodiment of the present invention also provides a system for automatically packaging the root canal fillers. The root canal filler packaging system according to the second embodiment includes: a plurality of arranging and feeding devices 410 to 450 and an automatic casing supplying unit 310 and 320, wherein the automatic casing supplying unit 310 and 320 comprises a plurality of casing grip units 310 that grip respective casings B2, and a grip moving unit 320 that moves the casing grip units 310 simultaneously.

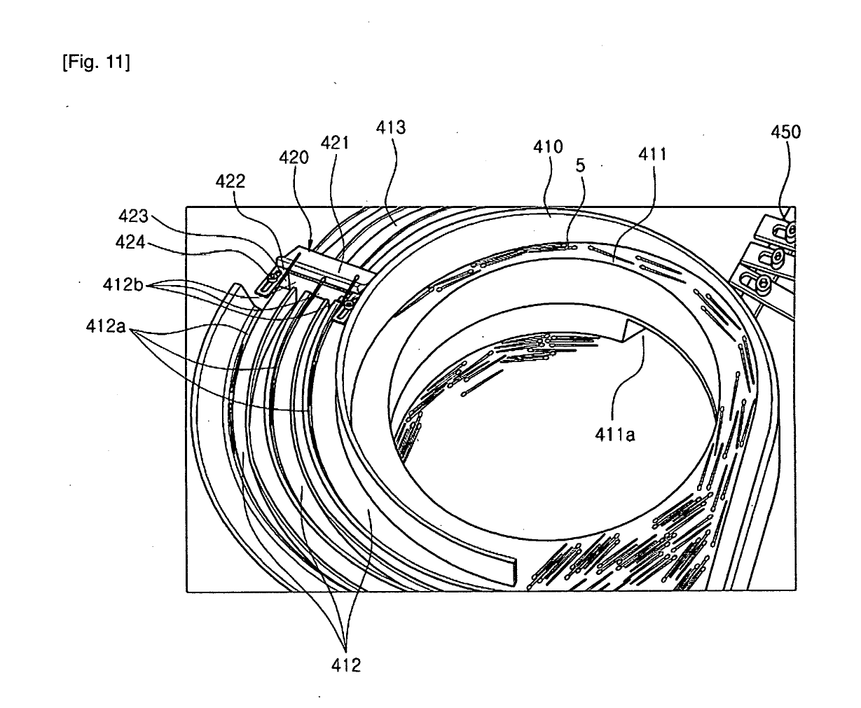

As shown in FIG. 11, the feeding unit 410 is a bowl feeder 410. The bowl feeder 410 is provided with a spiral track 411 on the inner circumferential surface thereof, with a vibrator connected to the bowl feeder 410. When vibrations are applied from the vibrator to the bowl feeder 410, the root canal fillers 5 are fed while being raised upward by the spiral track 411.

Further, the bowl feeder 410 is provided with three line feeding tracks 412 that are arranged in parallel with each other on the upper part of the bowl feeder 410, with an arranging groove 412a formed along each of the three line feeding tracks 412 so as to feed the root canal fillers 5 one by one even when the fillers 5 are fed chaotically on each of the three line feeding tracks 412. Therefore, the bowl feeder 410 can feed three root canal fillers 5 of the same kind simultaneously. Here, although three root canal fillers 5 are fed simultaneously, there may be slight time differences between the timings to feed the three fillers. Further, a broad dropping edge 412b having a large width is formed on the end of each of the line feeding tracks 412 so that three root canal fillers 5 that are being fed by the three line feeding tracks 412 can drop at the same time. Here, the broad dropping edge 412b is commonly connected to three connection tracks 413 that are arranged in parallel to each other.

Accordingly, the three root canal fillers 5 dropping after passing the dropping edges 412b are fed to the distributing unit 430 via the respective connection tracks 413, and are then automatically inserted into a casing B2. Here, the casing B2 is provided with six chambers partitioned by a plurality of partition walls 12, and the root canal fillers 5 put in the chambers of the casing B2 may be the fillers of the same kind or three fillers of the first kind and three fillers of the second kind.

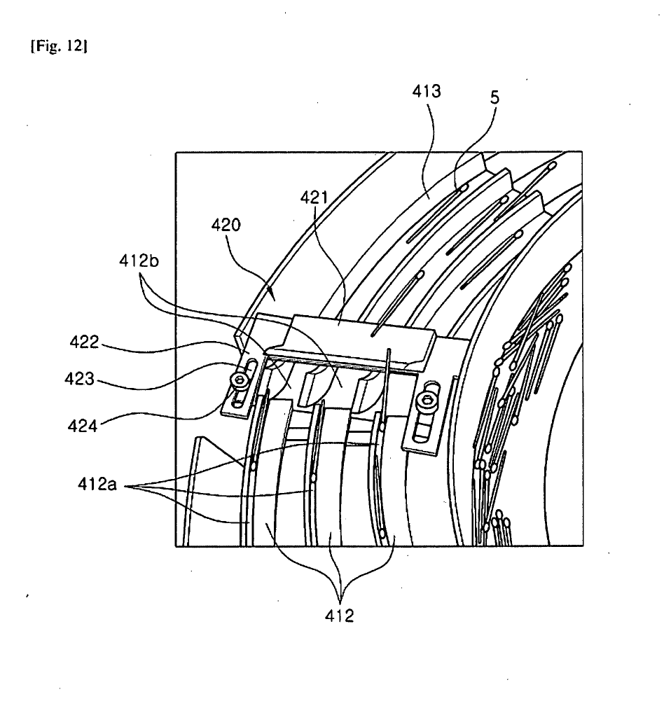

As shown in FIG. 12, the arranging unit 420 includes: a horizontal contact plate 421 that is placed on the paths extending from the line feeding tracks 412 to the connection tracks 413 and arranges the root canal fillers 5, a base frame 422 that supports the horizontal contact plate 421, an adjusting hole 423 that is formed through the base frame 422, and an adjusting bolt 424 fastened to the adjusting hole 423.

As an example of the horizontal contact plate 421 according to the second embodiment, an upward bent contact plate 421 having an upward bent portion at an end thereof in the same manner as that described with reference to FIG. 9a is used. The difference between the contact plates of the first and second embodiments resides in that the width of the contact plate 421 of the second embodiment is greater than that of the contact plate of the first embodiment, as shown in FIG. 12, such that the contact plate 421 can efficiently arrange the three root canal fillers 5 at the same time.

Accordingly, when root canal fillers 5 are being fed with the shanks 5b oriented in the feeding direction, the fillers 5 will be placed such that the ends of the shanks 5b are partially positioned on the horizontal contact plate 421, and when next root canal fillers 5 reach the positions in the above state, the first root canal fillers 5 are rotated by an angle of 180° while dropping. On the contrary, when root canal fillers 5 are being fed with the heads 5a oriented in the feeding direction, the root canal fillers 5 will directly drop just after passing the dropping edges 412b.

The distributing unit 430 functions to receive the root canal fillers 5 dropping from the feeding unit 410 and to distribute the fillers 5. As an example of the distributing unit 430, a line feeder may be used. Here, the upper end of the line feeder 430 is connected to the connection tracks 413 of the bowl feeder 410.

In the second embodiment, the three connection tracks 413 are provided and the line feeder 430 is provided with three distributing tracks 431, thus three root canal fillers 5 fed simultaneously by the three connection tracks 413 slide down along the respective distributing tracks 431 of the line feeder 430, and are inserted into the casing B2.

The counter 450 functioning to count the number of the root canal fillers 5 distributed by the line feeder 430 is installed on the line feeder 430, and the returning unit 440 functioning to eject pressurized air to excessive root canal fillers 5 so as to return the excessive fillers 5 to the feeding unit 410 is installed on an upper stream of the line feeder 430.

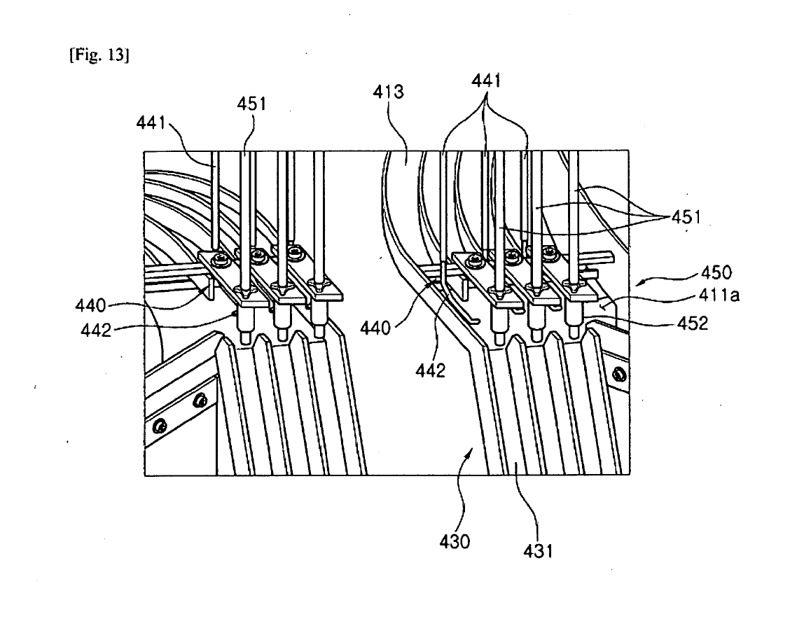

Here, as shown in FIG. 13, the counter 450 may be provided with sensors 452 installed at locations corresponding to the respective distributing tracks 431, so the sensors 452 sense and count the root canal fillers 5 when the fillers pass the sensors 452 on the respective distributing tracks 431.

The sensors 452 are installed at locations above the respective distributing tracks 431, and sense and count the root canal fillers 5 sequentially passing below the sensors 452 using light emitting devices and light receiving devices. Sensing results of the sensors 452 are applied to the returning unit 440 via the respective signal cables 451.

The returning unit 440 is provided with air supplying pipes 441 and air ejection nozzles 442, so the returning unit 440 can return excessive root canal fillers 5 to the bowl feeder 410 by blowing highly pressurized air onto the excessive fillers 5 from the air ejection nozzles 442. As shown in FIG. 13, the ends of the ejection nozzles 442 are bent so as to face the bowl feeder 410, so the ejection nozzles 442 can return excessive root canal fillers 5 to the bowl feeder 410 by blowing highly pressurized air onto the excessive fillers 5.

Accordingly, when the number of the discharged root canal fillers 5 counted by the counter 450 becomes equal to a preset number, the returning unit 440 returns excessive root canal fillers 5 to the feeding unit 410, so the system according to the second embodiment can insert the preset number of fillers 5 into the casing B2. The returned root canal fillers 5 are fed again through an inlet hole 411a (see FIG. 11) formed in a predetermined portion of the bottom surface of the bowl feeder 410.

Here, although there may be slight time differences between the timings to feed the three fillers via the three distributing tracks 431, it is required to distribute the same number of root canal fillers 5 to the casing B2 via the three distributing tracks 431, so the counters 450 and the returning units 440 provided on the three distributing tracks 431 must be operated independently.

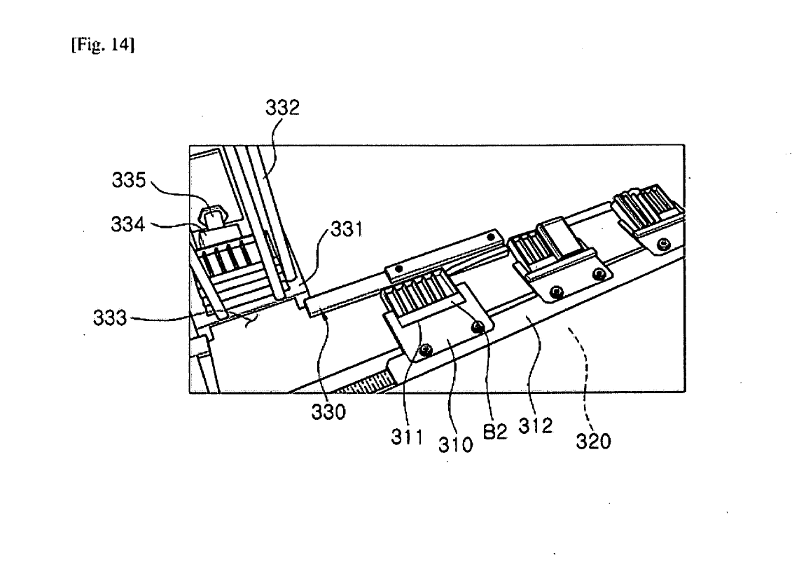

Further, as shown in FIG. 14, the root canal filler packaging system according to the second embodiment of the present invention includes: the arranging and feeding devices 410 to 450 and the automatic casing supplying unit 310 and 320, wherein the automatic casing supplying unit 310 and 320 comprises the casing grip units 310 that grip respective casings B2, and the grip moving unit 320 that moves the casing grip units 310 simultaneously.

In the second embodiment of the present invention, the number of the casing grip units 310 is equal to or greater than the number of the feeding units 410, so the casing grip units 310 may be placed at locations near the outlets of the plurality of line feeders 430, respectively.

The casing grip units 310 are provided with respective seat grooves 311, so the casings B2 can be seated in the seat grooves 311. Further, the casing grip units 310 are coupled to each other by a frame 312.

The grip moving unit 320 can move the plurality of casing grip units 310 simultaneously by a controller, so the discharged root canal fillers 5 can be inserted into the plurality of casings B2.

The system of this invention further includes a casing feeder 330 that feeds a plurality of casings B2 to the respective casing grip units 310. The casing feeder 330 includes: a base plate 331, a guide frame 332 vertically mounted to the base plate 331, a supply channel 333 formed through the base plate 331, a pushing member 334, and an actuating cylinder 335 functioning to actuate the pushing member 334.

Accordingly, a plurality of casings B2 are supplied through a supplying hole formed through the base plate 331 and are sequentially layered on top of each other on the bottom surface of the base plate 331. Here, the layered casings B2 are stably arranged by the guide frame 332 without being moved. To seat a casing B2 in a casing grip unit 310, the actuating cylinder 335 is operated to push the pushing member 334 forward, thereby pushing a lowermost one of the layered casings B2 and feeding the casing B2 to the casing grip unit 310 via the supply channel 333.

Thus, the casing B2 fed via the supply channel 333 is seated in the casing grip unit 310. When the grip moving unit 320 moves the casing grip units 310, the casings B2 each having six chambers are moved to the two arranging and feeding devices, respectively, and the canal fillers 5 are inserted in three chambers of each casing B2.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A device for automatically arranging and feeding root canal treatment materials, each of the root canal treatment materials having a conical shape tapering in direction from a head to an end of a shank, the device comprising:
a feeding unit feeding the root canal treatment materials in one direction, with a dropping edge formed on an end of the feeding unit so as to drop the root canal treatment materials; and
an arranging unit spaced apart from the dropping edge of the feeding unit by a distance for arrangement and arranging the root canal treatment materials such that the materials are oriented in the same direction; and
a distributing unit distributing the root canal treatment materials dropping from the feeding unit, wherein
the distance for arrangement is adjusted in such a way that, when a root canal treatment material is being fed with the head oriented in a feeding direction, the root canal treatment material directly drops just after passing the dropping edge; and when a root canal treatment material is being fed with the shank oriented in the feeding direction, the root canal treatment material comes into contact with the arranging unit after passing the dropping edge, and drops while being rotated by an angle of 180°.

2. The device for automatically arranging and feeding the root canal treatment materials according to claim 1, wherein the arranging unit includes: a horizontal contact plate arranged in parallel to the feeding direction, in which an end of the horizontal contact plate facing the dropping edge is spaced apart from the dropping edge by the distance for arrangement, wherein the root canal treatment material being fed with the shank oriented in the feeding direction drops with the end of the shank placed on the horizontal contact plate, so the root canal treatment material is rotated by an angle of 180°.

3. The device for automatically arranging and feeding the root canal treatment materials according to claim 2, wherein an end of the horizontal contact plate is provided with a downward bent portion, so the root canal treatment material being fed with the shank oriented in the feeding direction drops with the end of the shank moving upward over the downward bent portion, so the root canal treatment material is rotated by an angle of 180°.

4. The device for automatically arranging and feeding the root canal treatment materials according to claim 1, further comprising:
a counter installed on the distributing unit so as to count a number of the root canal treatment materials discharged by the distributing unit; and
a returning unit installed on an upper stream of the distributing unit so as to blow air onto root canal treatment materials being fed toward the distributing unit, thereby returning the materials to the feeding unit, wherein
when the number of the discharged root canal treatment materials counted by the counter becomes equal to a preset number, the returning unit returns excessive root canal treatment materials to the feeding unit.

5. A system for packaging root canal treatment materials, comprising:
a device for automatically arranging and feeding root canal treatment materials according to claim 1; and
an automatic casing supplying unit including: a plurality of casing grip units holding respective casings; and a grip moving unit moving the casing grip units simultaneously, wherein
a plurality of devices for automatically arranging and feeding root canal treatment materials are sequentially arranged in a linear arrangement, and the grip moving unit sequentially moves the casing grip units to the distributing units of the devices such that the root canal treatment materials discharged from the distributing units are inserted into the casings.

6. The system for packaging the root canal treatment materials according to claim 5, further comprising:
a casing feeder feeding the respective casings to the casing grip units.
